(19) United States
(12) Patent Application Publication
(10) Pub. No.: US 2010/0139378 A1
(43) Pub. Date: Jun. 10, 2010

(54) METHOD FOR DETERMINATION OF PORE WATER CONTENT IN EQUILIBRIUM WITH GAS HYDRATE IN DISPERSED MEDIA

(75) Inventors: Evgeniy Mikhailovich Chuvilin, Moscow (RU); Vladimir Aleksandrovich Istomin, Moscow (RU); Sergey Sergeevich Safonov, Moscow (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/631,064

(22) Filed: Dec. 4, 2009

(30) Foreign Application Priority Data
Dec. 5, 2008 (RU) 2008148000

(51) Int. Cl. G01N 5/02

(52) U.S. Cl. 73/73

(57) ABSTRACT

The method can be used in the field of gas hydrate geology for determining the pore water content in equilibrium with gas hydrate in different dispersed media, including rock, sedimentary deposits and soil systems. A dispersed-medium specimen which has been pre-dried and weighed is placed between, and in direct contact with, two plates of ice, ice-containing soil or ice-containing dispersed medium; then, the specimen is put, together with the plates, into an altitude chamber at a specified negative or positive Celsius temperature. A hydrate-forming gas is injected into the altitude chamber to a pressure exceeding the pressure of the “ice/gas/hydrate” three-phase equilibrium, and the specimen is held in the altitude chamber until equilibrium saturation of the specimen with moisture is achieved. The altitude chamber gas pressure is then decreased to the atmospheric level, the specimen is withdrawn and weighed, and the equilibrium moisture content of the specimen is determined from the difference between the specimen weights before and after the experiment.

### FIELD OF THE INVENTION

The invention relates to the field of gas hydrate geology and can be used for determining the pore water content in equilibrium with gas hydrate in different dispersed media, including rock, sedimentary deposits and soil systems.

### BACKGROUND OF THE INVENTION

Presently, numerous gas hydrate accumulations (so-called “clathrate compounds” of methane or other gases and water) have been found in the natural environment, both in the permafrost rock areas and in marine sedimentary rock. Natural gas hydrates are important not only from the geological point of view, but also from the practical point of view because of the prospects for gas production from hydrate-containing deposits. Data on the liquid water (“non-clathrate water”) content in equilibrium with gas hydrates in dispersed media are required for determining the phase state of hydrate-containing deposits and for evaluating their physical and mechanical properties, as well as for predicting how the hydrate-containing deposits will behave and how their properties will change in case of a variation in the pressure & temperature conditions and the geochemical conditions.

The analysis of the phase composition of sedimentary rock saturated with gas hydrates shows that under the hydrate formation conditions (the pressure of the hydrate-forming gas shall exceed the pressure of the “gas/water/hydrate” three-phase equilibrium or the “gas/ice/hydrate” equilibrium, depending on the temperature under consideration). The pore water in a dispersed medium does not fully pass into the hydrate, which considerably influences the mechanical, physicochemical and filtration properties of natural dispersed media. The residual pore water in a dispersed medium specimen can be divided into two types: the pore moisture which cannot transform into gas hydrate under specified pressure & temperature conditions and geochemical conditions (equilibrium “non-clathrate water”) and the water which can transform into gas hydrate but this process is not finished due to kinetic reasons. The pore moisture in equilibrium with gas hydrate at the specified pressure and temperature is called “non-clathrate water” (by analogy with “non-frozen water” in geocryology). The specific non-clathrate pore water content (in grams per gram of dry rock specimen) depends on the rock-contained pore water equilibrium with the gas phase (the hydrate-forming gas) and the gas hydrate in the volume phase. The equilibrium (non-clathrate) water content corresponds to the minimum possible amount of the liquid water phase in the pore space of the dispersed medium. The non-clathrate water content depends on the pressure, temperature, type of the dispersed medium (rock, deposits, soil systems) and hydrate-forming gas (hydrate-forming gases are natural gas and its components, i.e. methane, ethane, propane, isobutene, nitrogen, carbon dioxide, hydrogen sulphide, etc.). For reference, the non-frozen water content of a specific dispersed-medium specimen depends on the temperature only.

Making a reliable experimental quantitative estimation of the non-clathrate water content of dispersed media involves considerable difficulties. There is a literature-described method for studying the kinetics of the hydrate accumulation in dispersed media (Wright J. E., Chuvilin E. M., Dallimore S. R., Yakushev V. S., Nixon E. M., “Methane Hydrate Formation and Dissociation in Fine Sand at Temperatures near 0° C.”, in: Proc. of the 7^{th} International Permafrost Conference, Yellowknife, Canada, 1998, pp. 1147-1153; E. M. Chuvilin, E. V. Kozlova “Studies of Formation of Frozen Hydrate-containing Rock”, Earth Cryosphere, No. 1, 2005, p. 73-80). This method can be used for evaluating the equilibrium water content of hydrate-saturated rock, based on the analysis of the kinetic curve of the hydrate formation process in the pore space (by the dynamics of changes in the hydrate-forming gas pressure, with subsequent extrapolation). However, this method usually gives an overestimation because the phase equilibrium is practically unachievable in this method due to the fact that the pores of the dispersed medium become plugged with gas hydrate, resulting in a broken gas/water contact, which drastically delays the hydrate accumulation process in the specimen. Equilibration may therefore take a very long time; in particular, the equilibration time depends on the permeability of the gas hydrate shell formed on the surface of the pore water.

Also, a method has been suggested for evaluating the non-clathrate water content by the pressure and temperature conditions of the formation and decomposition of pore hydrate at a specified original pore moisture content of a specimen (Uchida T., Takeya S., Chuvilin E. M., Ohmura R. Nagao J., Yakushev V. S., Istomin V. A., Minagawa H., Ebinuma T., Narita H. “Decomposition of Methane Hydrates in Sand, Sandstone, Clays, and Glass Beads”, Journal of Geophysical Research, Vol. 109, B05206, 2004; S. M. Fedoseyev, V. R. Larionov “Study of Hydrate Formation in Porous Media”. Gas Industry, Special Issue “Gas Hydrates”, 2006, p. 28-35). However, the sensitivity of this method is low when the moisture content of the dispersed medium is low. Moisture redistribution may take place in the dispersed medium (soil) during the hydrate formation process, which affects the accuracy of determination of the non-clathrate water content in equilibrium (with gas hydrate).

### SUMMARY OF THE INVENTION

A reliable and accurate method for determination of the non-clathrate water content in the presence of gas hydrate is disclosed. No expensive equipment is required to carry out the disclosed method which is an advantage of the disclosed method.

According to one embodiment (designed for negative Celsius temperatures), the method for determination of the pore water content of dispersed media is implemented as follows. A dispersed-medium specimen which has been pre-dried and weighed is placed between, and in direct contact with, two plates of ice or ice-containing soil; then, the specimen is put, together with the plates of ice or ice-containing soil, into an altitude chamber at a specified negative Celsius temperature. A hydrate-forming gas is injected into the altitude chamber to a pressure exceeding the pressure of the “ice/gas/hydrate” three-phase equilibrium, and the specimen is held in the altitude chamber until equilibrium saturation of the specimen with moisture is achieved. The altitude chamber gas pressure is then decreased to the atmospheric level, the specimen is withdrawn and weighed, and the equilibrium moisture content of the specimen is determined from the difference between the specimen weights before and after the experiment.

According to another embodiment of the invention (for positive Celsius temperatures), a dispersed-medium specimen which has been pre-dried and weighed is placed between, and in direct contact with, two plates of wet soil; then, the specimen is put, together with the plates of soil, into an altitude chamber at a specified negative Celsius temperature, and a hydrate-forming gas is injected therein. After a portion of the pore ice contained in the plates has passed into the gas hydrate, the altitude chamber temperature is gradually increased to a specified positive Celsius temperature. The specimen is held under the specified pressure and temperature conditions until equilibrium saturation of the specimen with moisture is achieved and the altitude chamber gas pressure during this period shall exceed the pressure of the “volume water phase/gas/hydrate” three-phase equilibrium. The altitude chamber gas pressure is then decreased to the atmospheric level, the specimen is withdrawn and weighed, and the equilibrium moisture content of the specimen is determined from the difference between the specimen weights before and after the experiment.

### DETAILED DESCRIPTION OF THE PREFERRED EMBODIMENTS

Both pure gases (methane, ethane, propane, isobutane, carbon dioxide, nitrogen, hydrogen sulphide, etc.) and their mixtures, as well as natural gas or associated petroleum gas can be used as the hydrate-forming gas. Also, a gas which forms hydrates at a low pressure (close to the atmospheric pressure) (e.g. propane or isobutene) or volatile organic liquids which form clathrate hydrates (e.g. tetrahydrofuran and freons) can be used as the hydrate-forming gas.

Instead of plates of ice, it is possible to use plates of some other dispersed medium (some soil, e.g. sandstone) the pores of which contain ice. Also, it is possible to use plates of hydrate which are in the metastable state and which have been “ice-preserved from the surface” (i.e. the well-known “hydrate self-preservation” effect is used in this case).

The suggested method has certain advantages over the prior methods. There is no need to form hydrate inside the dispersed-medium specimen (soil specimen, rock specimen) under test, because hydrate is formed on the surface of a plate of ice (or on the surface of ice in a plate of ice-containing soil). Consequently, the original structure of the pore space of the specimen remains unaffected during the experiment. The specimen under test originally contains no moisture (is dried) and during the experiment it becomes saturated with moisture to a level not higher than that in equilibrium (with hydrate), using the film mechanism of moisture saturation to accelerate the equilibration process. That is, no overestimation of the non-clathrate moisture content is essentially possible in this method because the specimen can be saturated with the water phase to a level in equilibrium with hydrate only.

The method is implemented as follows. To prepare the dispersed-medium (rock) specimen for the experiment, the originally wet rock specimen is placed into a dedicated container and is gradually consolidated. The consolidated wet rock specimen is then shaped into plates of soil 4 cm in diameter and 0.5-0.8 cm thick which are thereafter dried at first under an air exhaust hood at room temperatures of 18° C. to 23° C. and then in a desiccator at a temperature of +105° C. to the air-dry state. The resulting homogenous dispersed-medium specimens (in the form of plates) are then weighed.

The procedure to be used for preparing plates of ice is as follows. Plates of ice are prepared by freezing distilled water in cylindrical cups 4 cm in diameter and about 1 cm thick. The dried plates of soil and ice are held in a cold room at a temperature of −8° C. to −10° C. (e.g. in a climate chamber where the temperature is usually maintained in the range of minus 5° C. to minus 15° C.). If necessary, the dispersed-medium specimen can be put into a desiccator. Then, each plate of dried soil is placed between, and in direct contact with, two plates of ice to form sandwich-type cartridges. The prepared cartridge consisting of the plates of soil and ice is then covered with polyethylene film fixed with an elastic band and is put into a dedicated altitude chamber cooled to the experimental temperature. A hydrate-forming gas is injected at a negative temperature of −8° C. to −10° C. into the altitude chamber filled with the cartridges consisting of the plates of dispersed medium and ice, to a pressure exceeding the pressure of the “ice/gas/hydrate” three-phase equilibrium. Prior to injecting the hydrate-forming gas, it is necessary to create a vacuum in the altitude chamber. The altitude chamber which has been filled with the cartridges consisting of the plates of soil and ice and which has been pressurized by the hydrate-forming gas is heat-insulated by using dedicated heat insulation and is put into a cooler at a constant negative Celsius temperature. The dispersed-medium specimen is held in the altitude chamber until equilibrium saturation of the specimen with moisture is achieved, i.e. until the thermodynamic equilibrium is established. The length of the experiment depends on the conditions required for achieving the phase equilibrium, and varies from a few days to 14 days (depending on the pressure & temperature conditions and the type of rock). During the experiment, the plates of ice become covered with a gas hydrate layer. As a result, the three-phase system is brought to equilibrium. The said three phases are: the solid volume gas hydrate (on the surface of the plates of ice), the hydrate-forming gas and the dispersed-medium specimen containing the liquid water phase (non-clathrate water). The process of ice transformation into hydrate does not need to be finished. After the experiment has been finished, the altitude chamber pressure is decreased to the atmospheric level, the chamber is then opened at negative temperatures of −6° C. to −8° C., the rock specimens are withdrawn and weighed and placed into a desiccator for re-drying. The specific equilibrium (non-clathrate) water content of the rock specimen is determined (as a percentage of the dry specimen weight) from the difference between the specimen weights before and after the drying. It is possible to change the altitude chamber pressure and temperature during the second and subsequent experiments, thus obtaining the dependence of the non-clathrate water content of this dispersed-medium specimen on the pressure and temperature for the hydrate-forming gas in use (e.g. methane).

Special methodological experiments have shown that the equilibration time will not exceed 14 days for all soil samples, irrespective of their compositions and experimental conditions.

Another embodiment of the method consists in determination of the equilibrium (non-clathrate) water content at positive Celsius temperatures. In this case, a pre-dried dispersed-medium specimen under test is placed between, and in direct contact with, two plates of ice-containing dispersed medium (rock, e.g. sandstone) and is then put into an altitude chamber at a negative Celsius temperature. After a portion of the ice contained in the plates has passed into the gas hydrate, the temperature is gradually increased and the specimen is then held at a specified positive Celsius temperature under a hydrate-forming gas pressure exceeding the pressure of the “volume water/gas/hydrate” three-phase equilibrium. After the thermodynamic equilibrium has been established, the equilibrium non-clathrate water content is determined by the weight method (just like in the embodiment described above). The plates may additionally contain gas hydrate in the metastable state (using the gas hydrate self-preservation effect). Also, it is possible to use plates of clathrate hydrate of a volatile organic liquid (e.g. tetrahydrofuran or freons).

Experimental tests have shown that, to determine the non-clathrate water content at positive Celsius temperatures, it is mostly advisable to use plates of frozen (ice-containing) quartz sand or frozen quartz sand containing preserved hydrate, as contact plates. The prepared cartridges consisting of the plates of air-dry soil and frozen sand are put into an altitude chamber and are held under the hydrate-forming gas pressure for 5 days at a constant negative temperature of −6° C. to −8° C. at first. Then, after a portion of the pore ice contained in the plates of sand has passed into the gas hydrate, the temperature is gradually increased (at a rate of 2 or 3° C.) to 0° C. at 1-day or 2-day intervals. Then, the required positive experimental temperature is set and the altitude chamber filled with the cartridges is held at the specified temperature for 7 to 10 days until the equilibrium moisture content of the plates of soil is achieved (depending on the pressure & temperature conditions and the type of rock). After the experiment has been finished, the altitude chamber is cooled to a negative temperature of −6° C. to −8° C., the altitude chamber pressure is decreased to the atmospheric level, the specimens are withdrawn to determine their gravimetric moisture content, which corresponds to the non-clathrate water content at a specified positive Celsius temperature. Below, we give a specific example of determination of the non-clathrate water content of kaolinite clay specimens in equilibrium with the gas phase (methane or methane gas hydrate). The experiment was carried out at a temperature of minus 7.5° C. and at a pressure of 4.34 MPa.

The air-dry plates of kaolinite clay 4 cm in diameter and 0.5-0.8 cm thick and the plates of ice 4 cm in diameter and about 1 cm thick, prepared by the method described above, were held in a cooling room at a temperature of −8° C. to −10° C.

Then, each plate of dry kaolinite clay was placed between, and in contact with, two plates of ice to form sandwich-type cartridges. The prepared cartridge consisting of the plates of soil and ice was then covered with polyethylene film fixed with an elastic band and was put into a dedicated altitude chamber cooled to the experimental temperature. After a vacuum has been created in the altitude chamber, methane cooled to the cooling-room temperature was injected at a negative temperature of −8° C. to −10° C. into the altitude chamber filled with the cartridges consisting of the plates of soil and ice, to a pressure of 4.6 MPa, which was 2.4 MPa higher than the equilibrium pressure of the hydrate formation from ice under these pressure and temperature conditions. The methane-pressurized altitude chamber filled with the cartridges consisting of the plates of kaolinite clay and ice was heat-insulated by using dedicated heat insulation and was put into a cooler at a constant negative Celsius temperature of −7.5° C. The altitude chamber containing the soil specimens was held for 14 days at the specified temperature of −7.5° C. The altitude chamber pressure decreased to 4.34 MPa during the experiment due to the methane gas hydrate formation on the surface of ice. After the experiment has been finished, the altitude chamber pressure was decreased to the atmospheric level, the chamber was then opened at negative temperatures of −6° C. to −8° C., the kaolinite clay specimens were withdrawn and weighed and placed into a desiccator for re-drying. The specific equilibrium (non-clathrate) water content of the rock specimen was determined (as a percentage of the dry specimen weight) from the difference between the specimen weights before and after the drying. According to the experimental data, the equilibrium moisture content of the kaolinite clay specimens in equilibrium with the gas phase (methane or methane gas hydrate) was equal to 1.71% (as a percentage of the dry specimen weight) at a temperature of minus 7.5° C. and at a pressure of 4.34 MPa.

For reference, a similar experiment was carried out in an altitude chamber at the atmospheric pressure of 0.1 MPa, using plates of dry kaolinite clay and ice. After the plates of kaolinite clay and ice had been in contact and had been held under isothermal conditions (at −7.5° C.), the equilibrium moisture (non-frozen water) content was equal to 3.8%. So, the non-frozen water content is considerably higher than the non-clathrate water content for these experimental conditions.

1. A method for determination of a pore water content in equilibrium with gas hydrate in a dispersed medium, comprising the steps of:
pre-drying a dispersed-medium specimen and measuring an initial weight by weighing;
placing the dispersed-medium specimen between, and in direct contact with, two plates of ice or ice-containing soil;
placing the dispersed-medium specimen together with the two plates of ice or ice-containing soil into an altitude chamber at a specified negative Celsius temperature;
injecting a hydrate-forming gas to a pressure that exceeds “ice-gas-hydrate” three-phase equilibrium pressure;
holding the dispersed-medium specimen in the altitude chamber until an equilibrium saturation of the dispersed-medium specimen with moisture is achieved;
decreasing the altitude chamber gas pressure to atmospheric level;
withdrawing the dispersed-medium specimen and measuring a final weight of the dispersed-medium specimen, and
determining an equilibrium moisture content of the dispersed-medium specimen from a difference between the initial and the final dispersed-medium specimen weights.

2. The method of claim 1, wherein the hydrate-forming gas is selected from the group comprising methane, ethane, propane, isobutane, carbon dioxide, nitrogen, hydrogen sulphide or their mixtures.

3. The method of claim 1, wherein the hydrate-forming gas is a natural gas or an associated petroleum gas.

4. The method of claim 1, wherein the hydrate-forming gas is a gas which forms hydrates at a low pressure.

5. The method of claim 1, wherein the hydrate-forming gas is a volatile organic liquid which forms clathrate hydrates.

6. The method of claim 1, wherein the plates of ice or ice-containing soil further comprise frozen-in gas hydrate in a stable or metastable state.

7. A method for determination of a pore water content in equilibrium with gas hydrate in a dispersed medium, comprising the steps of:
pre-drying a dispersed-medium specimen and measuring an initial weight by weighing;
placing the dispersed-medium specimen between, and in direct contact with, two plates of wet soil;
placing the dispersed-medium specimen together with the plates of wet soil into an altitude chamber at a specified negative Celsius temperature;
injecting a hydrate-forming gas to a pressure that exceeds “water volume phase-gas-hydrate” three-phase equilibrium pressure;
after a portion of a pore ice in the plates has passed into the gas hydrate, gradually increasing the altitude chamber temperature to a specified positive Celsius temperature;
holding the dispersed-medium specimen in the altitude chamber under a specified pressure and temperature condition until equilibrium saturation of the dispersed-medium specimen with moisture is achieved;
withdrawing the dispersed-medium specimen and measuring a final weight of the dispersed-medium specimen, and
determining equilibrium moisture content of the dispersed-medium specimen from a difference between the initial and the final specimen weights.

8. The method of claim 7, wherein the hydrate-forming gas is selected from the group comprising methane, ethane, propane, isobutane, carbon dioxide, nitrogen, hydrogen sulphide or their mixtures.

9. The method of claim 7, wherein the hydrate-forming gas is a natural gas or an associated petroleum gas.

10. The method of claim 7, wherein the hydrate-forming gas is a gas which forms hydrates at a low pressure.

11. The method of claim 7, wherein the hydrate-forming gas is a volatile organic liquid which forms clathrate hydrates.
